(19) United States
(12) Patent Application Publication
(10) Pub. No.: US 2014/0042074 A1
(43) Pub. Date: Feb. 13, 2014

(54) FILTRATION SYSTEM

(71) Applicants: Jung-min Noh, Seongnam-si (KR); Dae Joong Kim, Hwaseong-si (KR); Dong-eul Park, Suwon-si (KR); Ah Reum Lee, Yongin-si (KR); Yong-Cheol Shin, Seoul (KR); Kwang-Jin Lee, Yongin-si (KR)

(72) Inventors: Jung-min Noh, Seongnam-si (KR); Dae Joong Kim, Hwaseong-si (KR); Dong-eul Park, Suwon-si (KR); Ah Reum Lee, Yongin-si (KR); Yong-Cheol Shin, Seoul (KR); Kwang-Jin Lee, Yongin-si (KR)

(73) Assignees: KOLON INDUSTRIES, INC., Gwacheon-si, Gyeonggi-do (KR); KOLON BENIT CO., LTD., Gwacheon-si, Gyeonggi-do (KR)

(21) Appl. No.: 14/113,307

(22) PCT Filed: Apr. 26, 2012
(86) PCT No.: PCT/KR2012/003240

§ 371 Date: Oct. 22, 2013

(30) Foreign Application Priority Data
Apr. 29, 2011 (KR) 10-2011-0040479

(51) Int. Cl. B01D 63/02

(52) U.S. Cl. CPC B01D 63/02
USPC 210/257.2

(57) ABSTRACT

Disclosed is an energy-saving and eco-friendly filtration system which is capable of minimizing the amount of the energy required for the filtration, thereby remarkably reducing the cost of water treatment. The filtration system of the present invention comprises: a feed water tank for storing a feed water to be treated; a hollow fiber membrane module for filtering the feed water supplied from the feed water tank; and a filtrate tank for storing a filtrate produced by the hollow fiber membrane module, wherein the hollow fiber membrane module comprises a plurality of hollow fiber membranes for filtering the feed water, and the sum of head pressure of the feed water in the feed water tank and water pressure of the filtrate in accordance with siphon principle is higher than the threshold membrane pressure of the hollow fiber membranes.

### TECHNICAL FIELD

The present invention relates to a filtration system, and more particularly, to an energy-saving and eco-friendly filtration system which is capable of minimizing the amount of the energy required for the filtration, thereby remarkably reducing the cost of water treatment.

### BACKGROUND ART

The separation methods for water treatment to purify the water by removing impurities therefrom include a heating or phase-change method and a filtration membrane method.

The filtration membrane method is more advantageous than the heating or phase-change method in that the reliability of process of the filtration membrane method is relatively high because it is possible to obtain the water of quality as desired by controlling the size of the fine pores of the filtration membrane. Furthermore, since the filtration membrane method does not require a heating process, it can be advantageously used for water treatment using microorganisms that could be adversely affected by heat.

Among the filtration membrane methods is a method using a hollow fiber membrane. Typically, the hollow fiber membrane has been widely used in the field of precision filtration such as preparation of sterile water, drinking water, ultrapure water or the like. Recently, however, the application field of the hollow fiber membrane is extending to sewage/waste water disposal, separation of solids in sewage disposal tank, removal of suspended solids (SS) in industrial waste water, filtration of stream water, filtration of industrial water, filtration of pool water and the like.

The filtration method using the hollow fiber membrane can be classified into a pressurized-type and a submerged-type depending on the operation manner thereof.

According to the pressurized-type filtration method, the feed water is pressurized such that only pure water is allowed to penetrate the hollow fiber membrane and enter the lumen thereof, and thus the solid components such as impurities, sludge and the like can be separated from the pure water. Although requiring the additional facilities for the fluid circulation, the pressurized-type filtration method has an advantage in that it can produce more filtrate per unit time than the submerged-type. An example of the pressurized-type hollow fiber membrane module is explained in Korean patent application No. 10-2008-0091855.

On the other hand, according to the submerged-type filtration method, a negative pressure is applied to the lumen of the hollow fiber membrane submerged in the feed water in a bath such that only pure water is allowed to penetrate the hollow fiber membrane and enter the lumen thereof, and thus the solid components such as impurities, sludge and the like can be separated from the pure water. Although producing less filtrate per unit time than the pressurized-type, the submerged-type filtration method has an advantage in that it can reduce the installation cost as well as operating cost because it does not require any facilities for the fluid circulation. An example of the submerged-type hollow fiber membrane module is explained in Korean patent application No. 10-2007-0040261.

However, both of the conventional pressurized-type and submerged-type hollow fiber membrane modules require relatively large amount of energy and relatively high cost of water treatment because it is necessary to artificially produce the pressure difference between the outside and lumen of the hollow fiber membrane (AP: hereinafter ‘differential pressure’) to carry out the filtration. Further, since massive energy needs to be consumed for the filtration, the conventional filtration system has drawbacks in terms of environmental effects.

### DISCLOSURE

### Technical Problem

Therefore, the present invention is directed to a filtration system capable of preventing these limitations and drawbacks of the related art.

An aspect of the present invention is to provide a filtration system capable of naturally producing the differential pressure higher than the threshold membrane pressure by means of the head pressure of the feed water and/or the water pressure of the filtrate in accordance with the siphon principle.

Besides the aspects of the present invention as mentioned above, additional advantages and features of the present invention will be set forth in the description which follows or will become apparent to those having ordinary skill in the art from the following description.

### Technical Solution

In accordance with the one aspect of the present invention, there is provided a filtration system comprising: a feed water tank for storing a feed water to be treated; a hollow fiber membrane module for filtering the feed water supplied from the feed water tank; and a filtrate tank for storing a filtrate produced by the hollow fiber membrane module, wherein the hollow fiber membrane module comprises a plurality of hollow fiber membranes for filtering the feed water, and sum of head pressure of the feed water in the feed water tank and water pressure of the filtrate in accordance with siphon principle is higher than threshold membrane pressure of the hollow fiber membranes.

The aforementioned general description of the present invention is only for illustration of the present invention and should not be construed as limiting the scope thereof.

### Advantageous Effect

The present invention naturally produces the differential pressure higher than the threshold membrane pressure by means of the head pressure of the feed water and/or the water pressure of the filtrate in accordance with the siphon principle, thereby minimizing the energy consumed during the filtration process. Since the energy consumption is minimized, the cost of water treatment can be remarkably reduced and an eco-friendly filtration system can be facilitated.

Furthermore, since a feed water tank, a hollow fiber membrane module, and a filtrate tank are arranged along a vertical direction, the footprint of the filtration system can be reduced as compared to the conventional filtration system of planar arrangement, and thus the installation cost of the filtration system can be reduced.

Other features and advantages of the present invention may be newly found through practice of the present invention.

### DESCRIPTION OF DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 schematically illustrates a filtration system according to the first embodiment of the present invention;

FIG. 2 schematically illustrates a filtration system according to the second embodiment of the present invention;

FIG. 3 schematically illustrates a filtration system according to the third embodiment of the present invention;

FIG. 4 schematically illustrates a filtration system according to the fourth embodiment of the present invention;

FIG. 5 schematically illustrates a filtration system according to the fifth embodiment of the present invention; and

FIG. 6 schematically illustrates a filtration system according to the sixth embodiment of the present invention.

### MODE FOR INVENTION

The embodiments of the present invention explained below are provided only for illustration of the present invention and should not be construed as restricting the invention thereto, and those skilled in the art will appreciate that various alternations and modifications are possible, without departing from the scope and spirit of the invention. Accordingly, the present invention includes all alternations and modifications that fall within the scope of inventions described in claims and equivalents thereto.

The term ‘head pressure of feed water’ as used herein means a relative water pressure of the feed water with respect to the hollow fiber membrane module, the relative water pressure being created when the surface of the feed water is disposed above the hollow fiber membrane module.

The term ‘water pressure of filtrate in accordance with siphon principle’ as used herein means a relative pressure of the filtrate produced by the hollow fiber membrane module with respect to the filtrate tank, the relative pressure being created when the hollow fiber membrane module is disposed above the filtrate tank.

The term ‘threshold membrane pressure (TMP)’ as used herein means a minimum differential pressure necessary for the filtration process of the hollow fiber membrane, i.e., a minimum pressure difference between the inside and outside of the hollow fiber membrane required to enable the water outside the hollow fiber membrane to penetrate the membrane and enter the lumen thereof.

The filtration system of the present invention comprises a feed water tank for storing a feed water to be treated, a hollow fiber membrane module for filtering the feed water supplied from the feed water tank, and a filtrate tank for storing a filtrate produced by the hollow fiber membrane module. The hollow fiber membrane module comprises a plurality of hollow fiber membranes for filtering the feed water.

According to the present invention, the sum of the head pressure of the feed water in the feed water tank and the water pressure of the filtrate in accordance with siphon principle is higher than the threshold membrane pressure of the hollow fiber membranes.

Generally, the head pressure of the feed water and the water pressure of the filtrate in accordance with siphon principle can be calculated according to the following formula 1 and 2, respectively:

P_{H}=h₁*ρ*g Formula 1:

P_{S}=h₂*ρ*g Formula 2:

wherein P_{H} and P_{S} are the head pressure of the feed water and the water pressure of the filtrate in accordance with siphon principle respectively, h₁ and h₂ are respectively the height difference between the surface of the feed water in the feed water tank and the hollow fiber membrane module (hereinafter, ‘water level’ of feed water) and the height difference between the hollow fiber membrane module and the filtrate tank, ρ is the density of the water, and g is the gravitational constant.

1 atmospheric pressure (ATM) is 1.0332 kgf/cm², water of 10.332 m height corresponds to 1 atmospheric pressure, and thus, if the potential energy of water is converted into pressure, water of 1 m height corresponds to 0.1 kgf/cm².

The sum of the head pressure (P_{H}) of the feed water and the water pressure (P_{S}) of the filtrate in accordance with siphon principle needs to be sufficiently higher than the initial threshold membrane pressure (TMP) of the hollow fiber membrane because a certain amount of pressure drop is caused due to the friction when the fluid passes through the pipes and valves.

For instance, if a pressurized-type or submerged-type hollow fiber membrane module is operated under the condition of 1 m³/m²/day (40 LMH), since the initial threshold membrane pressure of the hollow fiber membrane is about 0.3 kfg/cm², the height difference (h₁) between the surface of the feed water and the hollow fiber membrane module and the height difference (h₂) between the hollow fiber membrane module and the filtrate tank may be adjusted in such a manner that the sum of the head pressure (P_{H}) of the feed water and the water pressure (P_{S}) of the filtrate in accordance with siphon principle is more than 1.0 kfg/cm².

Illustrated in Table 1 below are the water levels (h₁ and/or h₂) to be additionally secured for various pipes and valves in response to the pressure drop caused due to the friction with the pipes/valves.

TABLE 1

| | | Nominal | | | | | | | | | | | |
|---|---|---|---|---|---|---|---|---|---|---|---|---|---|
| | | Diameter | 25 | 32 | 40 | 50 | 65 | 80 | 90 | 100 | 125 | 150 | 200 |
| Pipe | Screw | 45 Elbow | 0.4 | 0.5 | 0.6 | 0.7 | 1 | 1.1 | 1.3 | 1.5 | 1.8 | 2.2 | 2.9 |
| | | 90 Elbow | 0.8 | 1.1 | 1.3 | 1.6 | 2 | 2.4 | 2.8 | 3.2 | 3.9 | 4.7 | 6.2 |
| | | T-junction | 1.7 | 2.2 | 2.5 | 3.2 | 4.1 | 4.9 | 5.6 | 6.3 | 7.9 | 9.3 | 12.5 |
| | Welding | 45 Elbow | 0.2 | 0.2 | 0.3 | 0.3 | 0.4 | 0.5 | 0.6 | 0.7 | 0.8 | 0.9 | 1.2 |
| | | 90 Elbow | 0.5 | 0.6 | 0.7 | 0.9 | 1.1 | 1.3 | 1.5 | 1.7 | 2.1 | 2.5 | 3.5 |
| | | (short) | | | | | | | | | | | |
| | | 90 elbow | 0.3 | 0.4 | 0.5 | 0.6 | 0.8 | 1 | 1.1 | 1.3 | 1.6 | 1.9 | 2.5 |
| | | (long) | | | | | | | | | | | |
| | | T-junction | 1.3 | 1.6 | 1.9 | 2.4 | 3.1 | 3.6 | 4.2 | 4.7 | 5.9 | 7 | 9.2 |

| | | | | | | | | | | | | |
|---|---|---|---|---|---|---|---|---|---|---|---|---|
| Valve | Gate valve | 0.2 | 0.2 | 0.3 | 0.3 | 0.4 | 0.5 | 0.6 | 0.7 | 0.8 | 1 | 1.3 |
| | Angle valve | 4.6 | 6 | 7 | 8.9 | 11.3 | 13.5 | 15.6 | 17.6 | 21.9 | 26 | 34.2 |
| | Check valve | 2.3 | 3 | 3.5 | 4.4 | 5.6 | 6.7 | 7.7 | 8.7 | 10.9 | 12.9 | 17 |
| | Globe valve | 9 | 11.8 | 13.8 | 17.7 | 21 | 26 | 29.6 | 34 | 43 | 52 | 61 |

Hereinafter, assuming that the head pressure of the feed water and the water pressure of the filtrate in accordance with siphon principle are respectively 0 or positive value, the embodiments of the present invention will be described in detail with reference to the annexed drawings.

However, one of the head pressure of the feed water and the water pressure of the filtrate in accordance with siphon principle may be negative value in accordance with the relative positions of the feed water tank, hollow fiber membrane module, and filtrate tank as long as the sum thereof is higher than the threshold membrane pressure of the hollow fiber membrane, and it should be understood that such filtration system is included in the spirit and scope of the present invention.

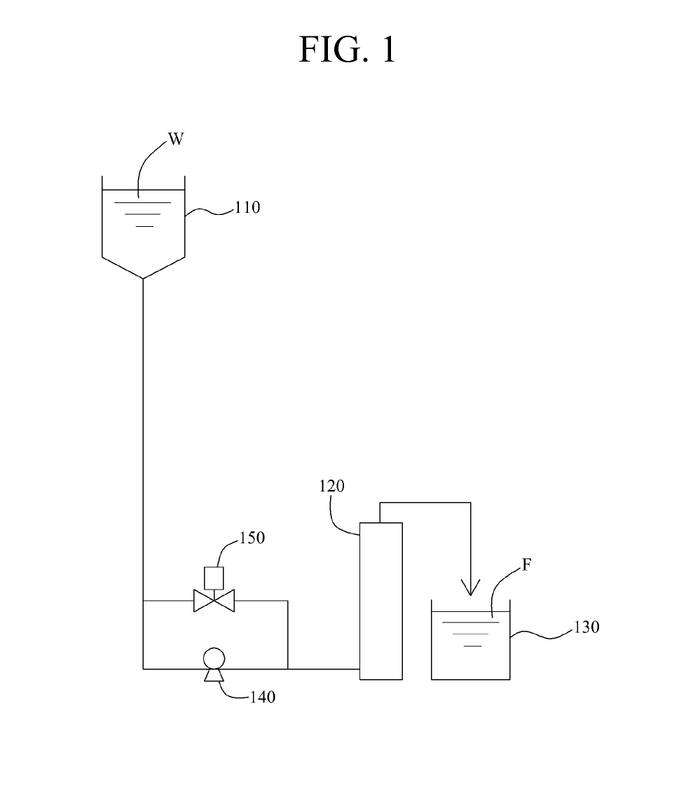

FIG. 1 schematically illustrates a filtration system according to the first embodiment of the present invention. As illustrated in FIG. 1, the filtration system according to the first embodiment of the invention comprises a feed water tank 110 for storing a feed water W to be treated, a hollow fiber membrane module 120 for filtering the feed water W supplied from the feed water tank 110, and a filtrate tank 130 for storing a filtrate F produced by the hollow fiber membrane module 120.

The hollow fiber membrane module 120 comprises a plurality of hollow fiber membranes for filtering the feed water W. Since the hollow fiber membrane module 120 is a pressurized-type module, the feed water W introduced in the hollow fiber membrane module 120 needs to be pressurized to be filtered. The differential pressure, i.e., the pressure difference between the inside and outside of the hollow fiber membrane, caused as the feed water W is pressurized has to be more than the threshold membrane pressure (TMP) of the hollow fiber membrane so that the pure water of the feed water W can penetrate the hollow fiber membrane.

According to the first embodiment of the invention, the hollow fiber membrane module 120 is below the feed water tank 110, and the hollow fiber membrane module 120 and feed water tank 110 are spaced apart from each other by such distance that, regardless of the amount of the feed water W in the feed water tank 110, the head pressure of the feed water W in the feed water tank 110 is always higher than the threshold membrane pressure (TMP) of the hollow fiber membranes.

In other words, according to the filtration system of the first embodiment of the invention, the head pressure of the feed water W in the feed water tank 110 is higher than the threshold membrane pressure (TMP) of the hollow fiber membrane. Hence, the pressure higher than the threshold membrane pressure (TMP) of the hollow fiber membrane is applied to the feed water W introduced into the hollow fiber membrane module 120 so that the filtration process can be carried out.

Optionally, as illustrated in FIG. 1, if the head pressure of the feed water W is higher than the threshold membrane pressure (TMP) of the hollow fiber membrane by more than a predetermined range, the feed water W may be controlled to flow into the hollow fiber membrane module 120 via a pressure reducing valve 150. The pressure reducing valve 150 reduces the pressure of the feed water W supplied to the hollow fiber membrane module 120. It must be kept in mind that, however, the pressure of the feed water W reduced by the pressure reducing valve 150 has to be still higher than the threshold membrane pressure (TMP) of the hollow fiber membrane.

As the filtration process by the hollow fiber membrane 120 is performed, the hollow fiber membranes are contaminated in the hollow fiber membrane module 120. The contamination of the hollow fiber membrane increases the threshold membrane pressure (TMP) of the hollow fiber membrane. Thus, as illustrated in FIG. 1, the filtration system according to the first embodiment of the invention may further comprise an auxiliary pressurizing pump 140. In case a filtration process solely based on the head pressure of the feed water W cannot be performed no longer due to the contamination of the hollow fiber membranes during the filtration process, the auxiliary pressurizing pump 140 provides additional pressure to the feed water W supplied to the hollow fiber membrane module 120 so that the filtration process can be performed in spite of the contamination of the hollow fiber membranes.

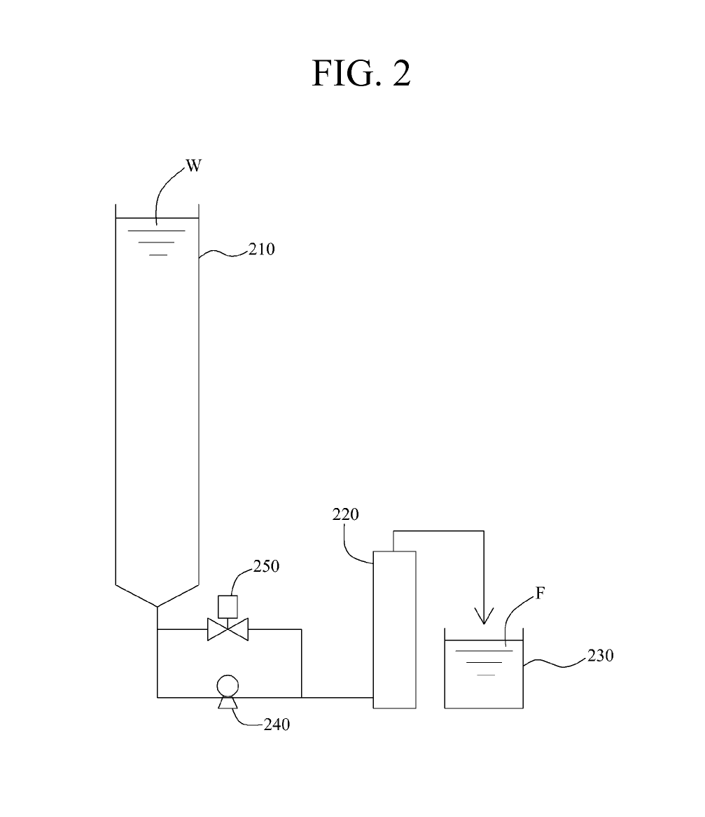

Hereinafter, the filtration system according to the second embodiment of the invention will be described with reference to FIG. 2.

As illustrated in FIG. 2, the filtration system according to the second embodiment of the invention comprises a feed water tank 210 for storing a feed water W to be treated, a hollow fiber membrane module 220 for filtering the feed water W supplied from the feed water tank 210, and a filtrate tank 230 for storing a filtrate F produced by the hollow fiber membrane module 220.

The hollow fiber membrane module 220 comprises a plurality of hollow fiber membranes for filtering the feed water W. The hollow fiber membrane module 220 is a pressurized-type module, and the differential pressure produced as the feed water W introduced in the hollow fiber membrane module 220 is pressurized has to be more than the threshold membrane pressure (TMP) of the hollow fiber membrane so that the pure water of the feed water W can penetrate the hollow fiber membrane.

According to the second embodiment of the invention, the feed water tank 210 has a depth long enough to enable the feed water W stored therein to have such water level that the head pressure of the feed water W in the feed water tank 210 is higher than the threshold membrane pressure (TMP) of the hollow fiber membrane.

Therefore, according to the filtration system of the second embodiment of the invention, when the feed water tank 210 is filled with sufficient amount of feed water W, the head pressure of the feed water W becomes higher than the threshold membrane pressure (TMP) of the hollow fiber membrane and a pressure higher than the threshold membrane pressure (TMP) of the hollow fiber membrane is applied to the feed water W introduced into the hollow fiber membrane module 220 so that the filtration process can be performed.

As illustrated in FIG. 2, the filtration system of the second embodiment of the invention may further comprise an auxiliary pressurizing pump 240 and a pressure reducing valve 250 for the same reasons as those of the filtration system of the first embodiment.

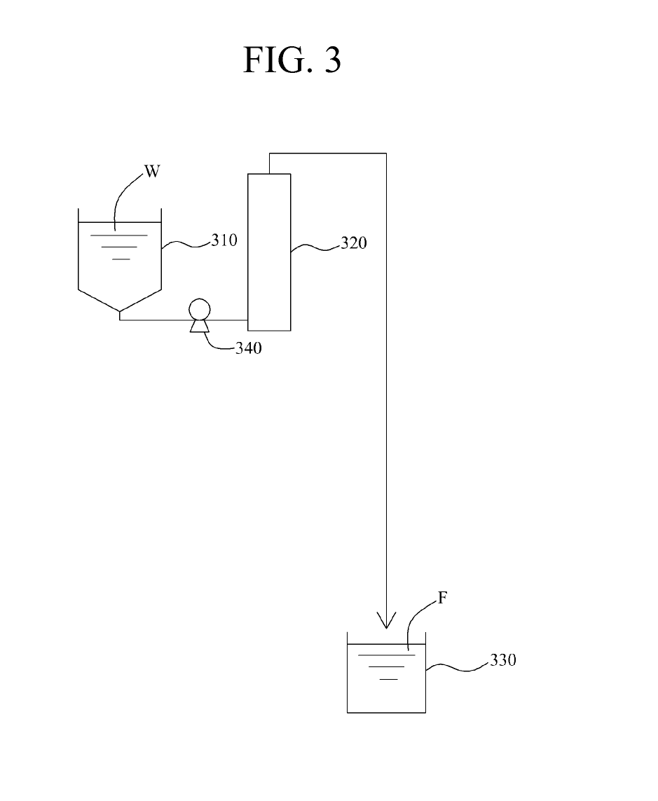

Hereinafter, the filtration system according to the third embodiment of the invention will be described with reference to FIG. 3.

As illustrated in FIG. 3, the filtration system according to the third embodiment of the invention comprises a feed water tank 310 for storing a feed water W to be treated, a hollow fiber membrane module 320 for filtering the feed water W supplied from the feed water tank 310, an initial power generating pump 340 for starting the filtration by the hollow fiber membrane module 320, and a filtrate tank 330 for storing a filtrate F produced by the hollow fiber membrane module 320.

The hollow fiber membrane module 320 comprises a plurality of hollow fiber membranes for filtering the feed water W. The hollow fiber membrane module 320 is a pressurized-type module spaced apart from the feed water tank 310, and the differential pressure produced as the feed water W introduced in the hollow fiber membrane module 320 is pressurized has to be more than the threshold membrane pressure (TMP) of the hollow fiber membrane so that the pure water of the feed water W can penetrate the hollow fiber membrane.

According to the third embodiment of the invention, while the surface of the feed water W in the feed water tank 310 is maintained at the same height level as the hollow fiber membrane module 320, the filtrate tank 330 is positioned below the hollow fiber membrane module 320. The initial power generating pump 340 pressurizes the feed water W introduced into the hollow fiber membrane module 320, thereby initiating the filtration process. The filtrate F produced through the filtration process by the hollow fiber membrane module 320 falls to the filtrate tank 330 disposed below the hollow fiber membrane module 320.

Once the filtrate F produced by the hollow fiber membrane module 320 begins to fall to the filtrate tank 330, the siphon principle is invoked. According to the third embodiment of the invention, the hollow fiber membrane module 320 and filtrate tank 330 are sufficiently spaced apart from each other such that the water pressure of the filtrate F in accordance with the siphon principle is higher than the threshold membrane pressure (TMP) of the hollow fiber membranes. Thus, once the filtration process begins, the filtration can be continuously performed without any help from the initial power generating pump 340.

The siphon refers to a tube that allows liquid present in a reservoir to flow to the lower level without inclining the reservoir, and the siphon principle means a phenomenon that the liquid is pushed up into the tube due to the relatively high pressure applied to the surface of the liquid in the reservoir. As mentioned above, the ‘water pressure of the filtrate in accordance with the siphon principle’ means a relative pressure of the filtrate F produced by the hollow fiber membrane module 320 with respect to the filtrate tank 330, the relative pressure being created when the hollow fiber membrane module 320 is disposed above the filtrate tank 330.

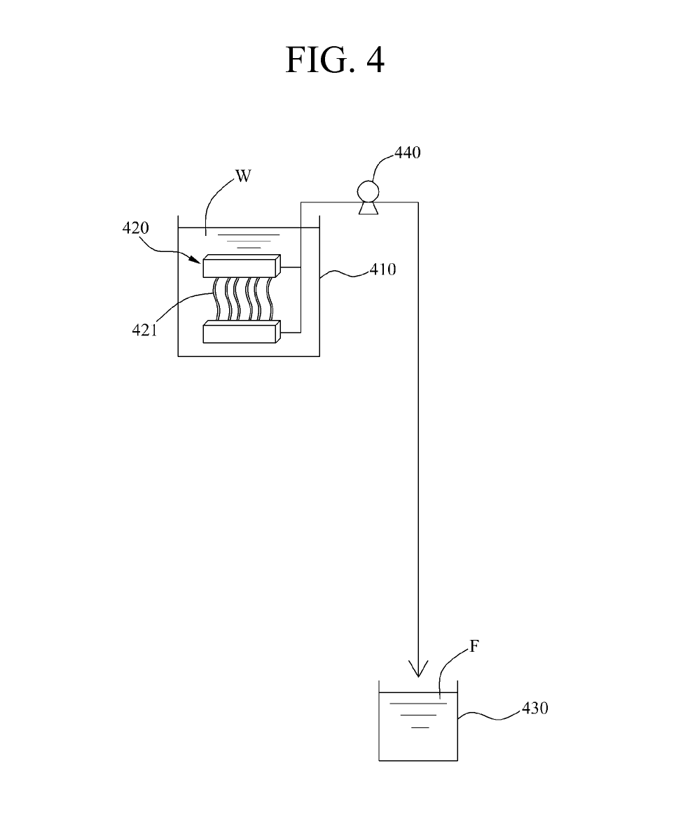

Hereinafter, the filtration system according to the fourth embodiment of the invention will be described with reference to FIG. 4.

As illustrated in FIG. 4, the filtration system according to the fourth embodiment of the invention comprises a feed water tank 410 for storing a feed water W to be treated, a hollow fiber membrane module 420 for filtering the feed water W supplied from the feed water tank 410, an initial power generating pump 440 for starting the filtration by the hollow fiber membrane module 420, and a filtrate tank 430 for storing a filtrate F produced by the hollow fiber membrane module 420.

The hollow fiber membrane module 420 comprises a plurality of hollow fiber membranes 421 for filtering the feed water W. The hollow fiber membrane module 420 is a submerged-type module performing the filtration process while submerged in the feed water W in the feed water tank 410, and the initial power generating pump 440 provides the hollow fiber membrane module 420 with the negative pressure for inducing the differential pressure more than the threshold membrane pressure (TMP) of the hollow fiber membrane 421 so that the filtration process begins.

According to the fourth embodiment of the invention, the filtrate F produced through the filtration process of the hollow fiber membrane module 420 started by the initial power generating pump 440 falls to the filtrate tank 430 disposed below the hollow fiber membrane module 420, i.e., below the feed water tank 410. Once the filtrate F produced by the hollow fiber membrane module 420 begins to fall to the filtrate tank 430, the siphon principle is invoked.

According to the fourth embodiment of the invention, the feed water tank 410 and filtrate tank 430 are sufficiently spaced apart from each other such that the water pressure in accordance with the siphon principle of the filtrate F produced by the hollow fiber membrane module 420 is higher than the threshold membrane pressure (TMP) of the hollow fiber membranes 421. Thus, once the filtration process begins, the filtration can be continuously performed without any help from the initial power generating pump 440.

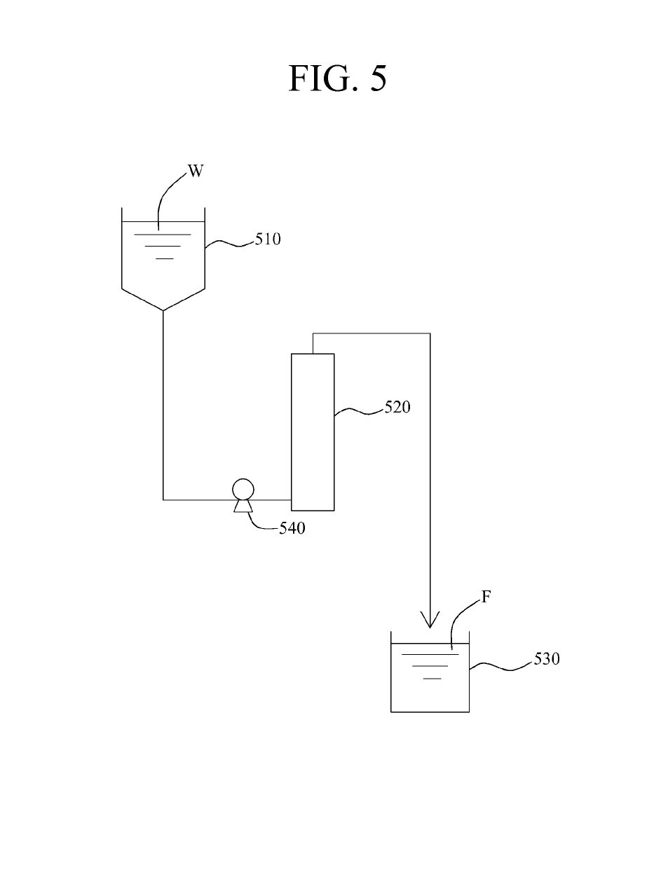

Hereinafter, the filtration system according to the fifth embodiment of the invention will be described with reference to FIG. 5.

As illustrated in FIG. 5, the filtration system according to the fifth embodiment of the invention comprises a feed water tank 510 for storing a feed water W to be treated, a hollow fiber membrane module 520 for filtering the feed water W supplied from the feed water tank 510, an initial power generating pump 540 for starting the filtration by the hollow fiber membrane module 520, and a filtrate tank 530 for storing a filtrate F produced by the hollow fiber membrane module 520.

The hollow fiber membrane module 520 is a pressurized-type module spaced apart from the feed water tank 510, and the differential pressure produced as the feed water W introduced in the hollow fiber membrane module 520 is pressurized has to be more than the threshold membrane pressure (TMP) of the hollow fiber membrane so that the pure water of the feed water W can penetrate the hollow fiber membrane.

According to the fifth embodiment of the invention, the hollow fiber membrane module 520 is below the feed water tank 510, and the filtrate tank 530 is below the hollow fiber membrane module 520.

The initial power generating pump 540 provides the feed water W supplied to the hollow fiber membrane module 520 with a pressure higher than the difference between the threshold membrane pressure (TMP) and the head pressure, thereby initiating the filtration process. In other words, the sum of the head pressure of the feed water W in the feed water tank 510 and pressure provided by the initial power generating pump 540 is applied to the feed water W introduced into the hollow fiber membrane module 520 so that the differential pressure higher than threshold membrane pressure (TMP) of the hollow fiber membrane is produced to initiate the filtration process.

The filtrate F produced through the filtration by the hollow fiber membrane module 520 falls to the filtrate tank 530 disposed below the hollow fiber membrane module 520.

Once the filtrate F produced by the hollow fiber membrane module 520 begins to fall to the filtrate tank 530, the siphon principle is invoked to replace the initial power generating pump 540.

That is, according to the fifth embodiment of the invention, the hollow fiber membrane module 520 is below the feed water tank 510, the filtrate tank 530 is below the hollow fiber membrane module 520, and the feed water tank 510 and filtrate tank 530 are spaced apart from each other by a distance long enough to guarantee that the sum of the head pressure of the feed water W in the feed water tank and the water pressure in accordance with siphon principle of the filtrate F produced by the hollow fiber membrane module 520 is higher than the threshold membrane pressure (TMP) of the hollow fiber membrane. Accordingly, once the filtration process is initiated, the filtration process can be performed continuously without any help from the initial power generating pump 540.

Although the aforementioned initial power generating pumps 340, 440 and 540 of the third to fifth embodiments of the present invention provide the pressure basically at the initial stage of the filtration process to initiate it, if the membrane contamination causing the increase of the threshold membrane pressure (TMP) occurs, they may additionally provide the pressure for the feed water W supplied to the hollow fiber membrane modules 320 and 520 or for the hollow fiber membrane module 420 so that the filtration process can be continuously carried out in spite of the membrane contamination.

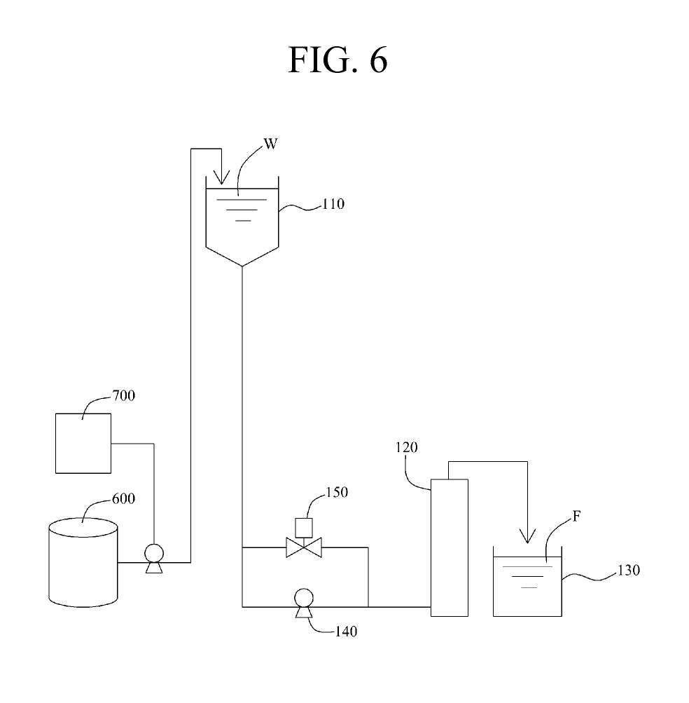

Hereinafter, the filtration system according to the sixth embodiment of the invention will be described with reference to FIG. 6.

The filtration system according to the sixth embodiment of the invention has basically same structure as that of the filtration system of the first embodiment except that it makes use of a renewable energy for the filtration process.

As explained above, according to the first embodiment of the invention, the feed water W in the feed water tank 110 has the potential energy high enough to guarantee that the head pressure of the feed water W in the feed water tank 110 is always higher than the threshold membrane pressure (TMP) of the hollow fiber membranes of the hollow fiber membrane module 120. To that end, the feed water needs to be supplied from a feed water source 600 to the feed water tank 110 positioned higher than the hollow fiber membrane module 120, which requires energy consumption.

The filtration system of the sixth embodiment of the invention further comprises, in addition to the elements of the filtration system of the first embodiment, a power source 700 for generating a power with a renewable energy and a pump P. The pump P is operated with the energy generated by the power source 700 to supply the feed water from the feed water source 600 to the feed water tank 110 positioned relatively higher. That is, the renewable energy is converted into the potential energy of the feed water.

The power source 700 generates the power with at least one of the renewable energies including solar light, solar heat, wind power, and geothermal heat. Optionally, the pump P may be a pump capable of directly exploit the renewable energy and operable with direct current.

Generally, the generation of power with the renewable energy cannot but be irregular since it totally depends on the natural environment. To supply the power in a stable manner despite the irregular generation thereof, the generated power should be continuously stored by means of an additional element, a storage battery.

According to the sixth embodiment of the invention, however, the additional element, i.e., a storage battery, is not required because the power generated with the renewable energy is immediately converted into the potential energy of the feed water, and thus the power source 700 for generating a power with a renewable energy can be used as a stable energy source. The utilization of the renewable energy, especially at the time zone when the electric charges are relatively high, allows the filtration process to be performed eco-friendly and reduces the filtration costs as well.

Although the eco-friendly filtration system comprising the renewable energy-related elements in addition to the elements of the filtration system of the first embodiment is described above as the sixth embodiment of the invention, eco-friendly filtration systems can be facilitated by adding the renewable energy-related elements to the to the second to fifth embodiments respectively.

When the filtration system comprises a pressurized-type hollow fiber membrane module rather than a submerged-type hollow fiber membrane module, the loss of the head pressure can minimized by introducing the feed water to be treated into the module through the top portion thereof and discharging the filtrate passing through the hollow fiber membrane out of the module through the bottom portion thereof.

According to the embodiments of the present invention as described above, since the differential pressure higher than the threshold membrane pressure can be naturally generated by the head pressure of the feed water and/or the water pressure of the filtrate in accordance with the siphon principle, the energy consumption during the filtration process can be minimized, and thus the costs of water treatment can be remarkably reduced.

1. A filtration system comprising:
a feed water tank for storing a feed water to be treated;
a hollow fiber membrane module for filtering the feed water supplied from the feed water tank; and
a filtrate tank for storing a filtrate produced by the hollow fiber membrane module,
wherein the hollow fiber membrane module comprises a plurality of hollow fiber membranes for filtering the feed water, and
sum of head pressure of the feed water in the feed water tank and water pressure of the filtrate in accordance with siphon principle is higher than threshold membrane pressure of the hollow fiber membranes.

2. The filtration system of claim 1, wherein the head pressure of the feed water in the feed water tank is higher than the threshold membrane pressure of the hollow fiber membranes.

3. The filtration system of claim 2, wherein the hollow fiber membrane module is below the feed water tank, and
the hollow fiber membrane module and the feed water tank are spaced apart from each other by such distance that, regardless of an amount of the feed water in the feed water tank, the head pressure of the feed water in the feed water tank is always higher than the threshold membrane pressure of the hollow fiber membranes.

4. The filtration system of claim 2, wherein the feed water tank has a depth long enough to enable the feed water stored therein to have such water level that the head pressure of the feed water in the feed water tank is higher than the threshold membrane pressure of the hollow fiber membranes.

5. The filtration system of claim 2, further comprising an auxiliary pressurizing pump for providing additional pressure to the feed water supplied to the hollow fiber membrane module in case, due to contamination of the hollow fiber membranes during a filtration process, the filtration process solely based on the head pressure of the feed water cannot be performed no longer.

6. The filtration system of claim 2, further comprising a pressure reducing valve for reducing a pressure of the feed water supplied to the hollow fiber membrane module in case the head pressure of the feed water is higher than the threshold membrane pressure of the hollow fiber membranes by more than a predetermined range.

7. The filtration system of claim 1, further comprising an initial power generating pump for starting filtration by the hollow fiber membrane module,
wherein the filtrate tank is below the hollow fiber membrane module, and
the water pressure of the filtrate in accordance with the siphon principle is higher than the threshold membrane pressure of the hollow fiber membranes.

8. The filtration system of claim 7, wherein the hollow fiber membrane module is a submerged-type hollow fiber membrane module performing filtration while submerged in the feed water in the feed water tank, and
the initial power generating pump supplies a negative pressure to the hollow fiber membrane module.

9. The filtration system of claim 7, wherein the hollow fiber membrane module is a pressurized-type hollow fiber membrane module spaced apart from the feed water tank, and
the initial power generating pump applies a pressure to the feed water supplied to the hollow fiber membrane module.

10. The filtration system of claim 1, further comprising an initial power generating pump for starting filtration with the hollow fiber membrane module,
wherein the hollow fiber membrane module is below the feed water tank, and
the filtrate tank is below the hollow fiber membrane module.

11. The filtration system of claim 10, wherein the initial power generating pump provides the feed water supplied to the hollow fiber membrane module with a pressure higher than difference between the threshold membrane pressure and the head pressure.

12. The filtration system of claim 1, further comprising:
a feed water source;
a power source for generating a power with a renewable energy; and
a pump for supplying the feed water to be treated from the feed water source to the feed water tank by means of the power supplied from the power source.
